(19) United States
(12) Patent Application Publication
(10) Pub. No.: US 2020/0408134 A1
(43) Pub. Date: Dec. 31, 2020

(54) RESERVE TANK DEVICE AND COOLING SYSTEM

(71) Applicant: DENSO CORPORATION, Kariya-city (JP)

(72) Inventors: Taichi ASANO, Kariya-city (JP); Ryoichi SANADA, Kariya-city (JP); Akira YAMANAKA, Kariya-city (JP)

(21) Appl. No.: 17/018,488

(22) Filed: Sep. 11, 2020

Related U.S. Application Data
(63) Continuation of application No. PCT/JP2019/006537, filed on Feb. 21, 2019.

(30) Foreign Application Priority Data
Mar. 14, 2018 (JP) 2018-047124
Feb. 1, 2019 (JP) 2019-017187

(51) Int. Cl. F01P 7/14; F01P 3/12; F01P 11/08; F01P 11/12; B60K 11/02

(52) U.S. Cl. CPC F01P 7/14; F01P 3/12; F01P 11/08; F01P 2060/02; B60K 11/02; F01P 2007/146; F01P 11/12

(57) ABSTRACT

A reserve tank device includes a first reserve tank, a second reserve tank, a passage switching member, and a gas-liquid separator. The first reserve tank reserves a cooling water flowing through an engine cooling circuit. The second reserve tank reserves a cooling water flowing through an auxiliary machine cooling circuit. The gas-liquid separator is disposed in the first reserve tank and removes bubbles from the cooling water flowing through the first reserve tank.

### CROSS REFERENCE TO RELATED APPLICATION

The present application is a continuation application of International Patent Application No. PCT/JP2019/006537 filed on Feb. 21, 2019, which designated the U.S. and claims the benefit of priority from Japanese Patent Application No. 2018-047124 filed on Mar. 14, 2018 and Japanese Patent Application No. 2019-017187 filed on Feb. 1, 2019. The entire disclosures of all of the above applications are incorporated herein by reference.

### TECHNICAL FIELD

The present disclosure relates to a reserve tank device mounted in a vehicle and a cooling system including the reserve tank device.

### BACKGROUND ART

A cooling system cools a cooling target such as an internal combustion engine and auxiliary machines in a vehicle by circulating an antifreeze fluid or a water (hereinafter refereed as a “cooling water”) through a cooling circuit. The cooling circuit includes a reserve tank to absorb a volumetric change of the cooling water generated by a temperature change of the cooling water.

### SUMMARY

A reserve tank device is disposed in both an engine cooling circuit through which a cooling water for cooling an internal combustion engine mounted in a vehicle circulates and an auxiliary machine cooling circuit through which a cooling water for cooling an auxiliary machine mounted in the vehicle circulates. The reserve tank device includes a first reserve tank, a second reserve tank, a passage switching member, and a gas-liquid separator. The first reserve tank reserves the cooling water circulating through the engine cooling circuit and a second reserve tank reserves the cooling water circulating through the auxiliary machine cooling circuit. The passage switching member is configured to selectively allow and forbid the cooling water to flow between the engine cooling circuit and the auxiliary machine cooling circuit. The gas-liquid separator is disposed in the first reserve tank and separates bubbles from the cooling water flowing through the first reserve tank.

A reserve tank device is disposed in multiple auxiliary machine cooling circuits through which a cooling water for cooling multiple auxiliary machines mounted in a vehicle circulates. The reserve tank device includes a first reserve tank, a second reserve tank, a passage switching member, and a gas-liquid separator. The first reserve tank reserves the cooling water circulating through a first auxiliary machine cooling circuit of the multiple auxiliary machine cooling circuits and the second reserve thank reserves the cooling water circulating through a second auxiliary machine cooling circuit of the multiple auxiliary machine cooling circuits. The passage switching member is configured to selectively allow and forbid the cooling water to flow between the first auxiliary machine circuit and the second auxiliary machine circuit. The gas-liquid separator is disposed in the first reserve tank and separates bubbles from the cooling water flowing through the first reserve tank.

### BRIEF DESCRIPTION OF DRAWINGS

FIG. 1 is a diagram of a cooling system including a reserve tank device according to a first embodiment.

FIG. 2 is a cross-sectional view of the reserve tank device in a part II of FIG. 1.

FIG. 3 is a flow chart of a control process of the cooling system according to the first embodiment.

FIG. 4 is a cross-sectional view of a reserve tank device according to a second embodiment.

FIG. 5 is a cross-sectional view of a reserve tank device according to a third embodiment.

FIG. 6 is a cross-sectional view of a reserve tank device according to a fourth embodiment.

FIG. 7 is a diagram of a cooling system including a reserve tank device according to a fifth embodiment.

FIG. 8 is a cross-sectional view of the reserve tank device in a part VIII of FIG. 7.

FIG. 9 is a cross-sectional view of a reserve tank device according to a sixth embodiment.

FIG. 10 is a cross-sectional view of a reserve tank device according to a seventh embodiment.

FIG. 11 is a cross-sectional view of a reserve tank device according to an eighth embodiment.

### DESCRIPTION OF EMBODIMENTS

To begin with, examples of relevant techniques will be described.

A cooling system cools a cooling target such as an internal combustion engine and auxiliary machines in a vehicle by circulating an antifreeze fluid or a water (hereinafter refereed as a “cooling water”) through a cooling circuit. The cooling circuit includes a reserve tank to absorb a volumetric change of the cooling water generated by a temperature change of the cooling water.

A reserve tank includes a gas-liquid separator. The gas-liquid separator includes a labyrinth configuration in the reserve tank to separate bubbles in the cooling water from the cooling water.

The gas-liquid separator in the reserve tank has a function to separate bubbles in the cooling water generated when the cooling water is supplied into the cooling circuit. The gas-liquid separator also has a function to separate bubbles in the cooling water generated while the cooling water is circulating through the cooling circuit.

Recently, the number of vehicles including multiple cooling circuits is increasing in response to a diversity of cooling targets mounted in the vehicle. If the vehicle includes multiple gas-liquid separators corresponding to all of the reserve tanks mounted in the multiple cooling circuits, a size of the cooling system is increased.

When the cooling target and the reserve tank are serially disposed in the cooling circuit and the reserve tank has the gas-liquid separator, a pressure loss of the cooling water flowing through the cooling circuit is increased.

It is objective of the present disclosure to provide a reserve tank and a cooling system that can be downsized and decrease a pressure loss.

A reserve tank device is disposed in both an engine cooling circuit through which a cooling water for cooling an internal combustion engine mounted in a vehicle circulates and an auxiliary machine cooling circuit through which a cooling water for cooling an auxiliary machine mounted in the vehicle circulates. The reserve tank device includes a first reserve tank, a second reserve tank, a passage switching member, and a gas-liquid separator. The first reserve tank reserves the cooling water circulating through the engine cooling circuit and a second reserve tank reserves the cooling water circulating through the auxiliary machine cooling circuit. The passage switching member is configured to selectively allow and forbid the cooling water to flow between the engine cooling circuit and the auxiliary machine cooling circuit. The gas-liquid separator is disposed in the first reserve tank and separates bubbles from the cooling water flowing through the first reserve tank.

According to this, when the cooling water is supplied into the first reserve tank in a state where the passage switching member allows the cooling water to flow between the engine cooling circuit and the auxiliary machine cooling circuit, the cooling water is supplied into both the engine cooling circuit and the auxiliary machine cooling circuit. The gas-liquid separator disposed in the first reserve tank separates bubbles generated when the cooling water is supplied into the reserve tank device. As a result, the cooling water without bubbles is provided into both the engine cooling circuit and the auxiliary machine cooling circuit. Accordingly, the reserve tank device commonly uses the gas-liquid separator disposed in the first reserve tank for the engine cooling circuit and the auxiliary machine cooling circuit when the cooling water is supplied into the engine cooling circuit and the auxiliary machine cooling circuit. Thus, it is possible to remove the gas-liquid separator from the second reserve tank or reduce an area occupied by the gas-liquid separator in the second reserve tank.

When the passage switching member is operated to forbid the cooling water to flow between the engine cooling circuit and the auxiliary cooling circuit, the cooling water circulating through the engine cooling circuit and the cooling water circulating through the auxiliary machine cooling circuit are not mixed with each other. The gas-liquid separator disposed in the first reserve tank removes, from the cooling water, bubbles generated when the cooling water circulates through the engine cooling circuit during an operation of the internal combustion engine. Bubbles are rarely generated in the cooling water circulating through the auxiliary machine cooling circuit. According to this reserve tank, the gas-liquid separator is not disposed in the second reserve tank or disposed both in the first reserve tank and the second reserve tank such that an area occupied by the gas-liquid separator in the second reserve tank is small. As a result, the second reserve tank can be reduced in size and a pressure loss of the cooling water circulating through the auxiliary machine cooling circuit can be reduced.

A reserve tank device is disposed in multiple auxiliary machine cooling circuits through which a cooling water for cooling multiple auxiliary machines mounted in a vehicle circulates. The reserve tank device includes a first reserve tank, a second reserve tank, a passage switching member, and a gas-liquid separator. The first reserve tank reserves the cooling water circulating through a first auxiliary machine cooling circuit of the multiple auxiliary machine cooling circuits and the second reserve thank reserves the cooling water circulating through a second auxiliary machine cooling circuit of the multiple auxiliary machine cooling circuits. The passage switching member is configured to selectively allow and forbid the cooling water to flow between the first auxiliary machine circuit and the second auxiliary machine circuit. The gas-liquid separator is disposed in the first reserve tank and separates bubbles from the cooling water flowing through the first reserve tank.

Accordingly, when the cooling water is supplied into the first reserve tank in a state where the passage switching member allows the cooling water to flow between the first auxiliary cooling circuit and the second auxiliary cooling circuit, the cooling water is supplied into both the first auxiliary machine cooling circuit and the second auxiliary machine cooling circuit. The gas-liquid separator disposed in the first reserve tank removes bubbles generated when the cooling water is supplied into the reserve tank device. Thus, the cooling water without bubbles is provided into both the first auxiliary machine cooling circuit and the second auxiliary machine cooling circuit. That is, the reserve tank device can commonly use the gas-liquid separator disposed in the first reserve tank when the cooling water is supplied into both the first auxiliary machine cooling circuit and the second auxiliary machine cooling circuit. Accordingly, the second reserve tank can remove the gas-liquid separator or an area occupied by the gas-liquid separator in the second reserve tank can be reduced. Therefore, the reserve tank device can be reduced in size and a pressure loss of the cooling water flowing through the second auxiliary cooling circuit can be reduced.

When the passage switching member is operated to forbid the cooling water to flow between the first auxiliary machine cooling circuit and the second auxiliary machine cooling circuit, the cooling water circulating through the first auxiliary machine cooling circuit and the cooling water circulating through the second auxiliary machine cooling circuit are not mixed with each other. Thus, the temperature of the cooling water circulating through the first auxiliary cooling circuit can be different from the temperature of the cooling water circulating through the second auxiliary cooling circuit. Accordingly, a first auxiliary machine cooled by the first auxiliary machine cooling circuit and a second auxiliary machine cooled by the second auxiliary machine cooling circuit can be cooled at different desired temperatures.

A cooling system mounted in a vehicle includes the reserve tank described above and multiple cooling circuits through which the cooling water reserved in the first reserve tank and the second reserve tank of the reserve tank device circulates to cool an internal combustion engine or an auxiliary machine.

According to this, because the cooling system can commonly use the gas-liquid separator in the first reserve tank for the multiple cooling circuits, the gas-liquid separator is not disposed in the second reserve tank or an area occupied by the gas-liquid separator in the second reserve tank can be reduced. Thus, the reserve tank device can be reduced in size and a pressure loss of the cooling water circulating through the cooling circuit through which the cooling water reserved in the second reserve tank circulates can be reduced.

Hereinafter, embodiments of the present disclosure will be described with reference to drawings. The same reference numerals are assigned to the same or equivalent portions of the embodiments with each other and redundant explanations of the embodiments are omitted.

### First Embodiment

A first embodiment will be described with reference to drawings. A reserve tank device 1 in this embodiment is disposed in a cooling system 100 mounted in a vehicle. The cooling system 100 cools an internal combustion engine 2 and an auxiliary machine 3 with a water or antifreeze water circulating through a cooling circuit. The internal combustion engine 2 and the auxiliary machine 3 are cooling targets. Hereinafter, the water or the antifreeze water is referred as a cooling water.

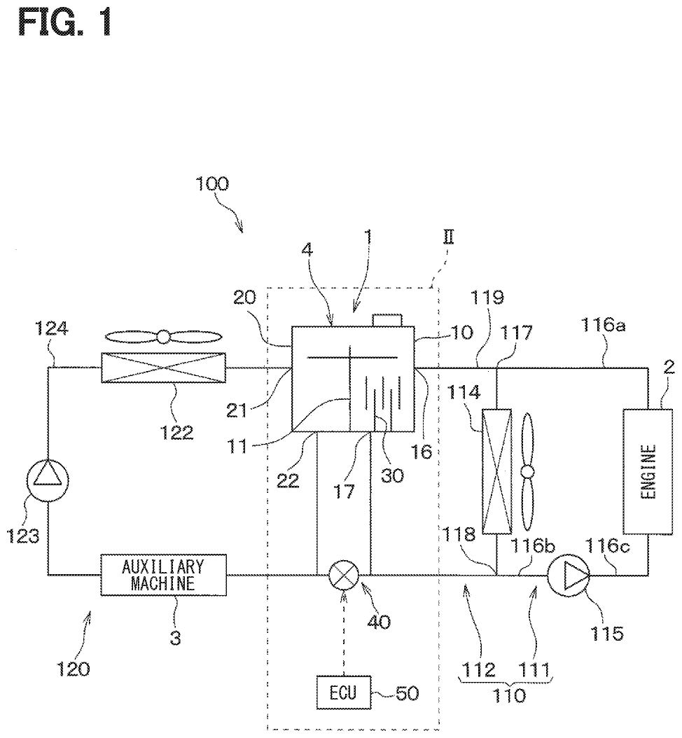

As shown in FIG. 1, the cooling system 100 includes an engine cooling circuit 110, an auxiliary machine cooling circuit 120, and the reserve tank device 1. The engine cooling circuit 110 is a cooling circuit through which a cooling water for cooling the internal combustion engine 2 mounted in the vehicle for vehicle travelling is circulating. The auxiliary machine cooling circuit 120 is a cooling circuit through which a cooling water for cooling an auxiliary machine 3 mounted in the vehicle is circulating. The auxiliary machine 3 may be an intercooler, an inverter, and a battery. The reserve tank device 1 is a device to reserve the cooling water circulating through the engine cooling circuit 110 and the auxiliary machine cooling circuit 120. The reserve tank device 1 includes a first reserve tank 10, a second reserve tank 20, a gas-liquid separator 30, and a passage switching member 40.

At first, a configuration of the cooling system 100 will be described.

The engine cooling circuit 110 includes a main circuit 111 and a bypass circuit 112. The main circuit 111 is a circuit annually connecting between the internal combustion engine 2 for vehicle traveling, a first radiator 114, and a first water pump 115 with pipes 116a, 116b, and 116c. The first radiator 114 is a heat exchanger to exchange heat between the cooling water and an outside air. The first water pump 115 circulates the cooling water through the engine cooling circuit 110. When the first water pump 115 is operated, the cooling water circulating through the engine cooling circuit 110 is heated by passing through a water jacket (not shown) disposed in the internal combustion engine 2. The cooling water is cooled by releasing heat to an air drawn into an engine compartment of the vehicle upon flowing through the first radiator 114. Such circulation of the cooling water through the engine cooling circuit 110 prevents the internal combustion engine 2 from being overheated or overcooled and keeps an appropriate temperature of the internal combustion engine 2.

The bypass circuit 112 is a circuit through which a part of the cooling water flowing through the main circuit 111 bypasses. The main circuit 111 described above includes a first branch 117 and a second branch 118. The first branch 117 is disposed at a part of the pipe 116a connecting the internal combustion engine 2 to the first radiator 114 and the second branch 118 is disposed at a part of the pipe 116b connecting the first radiator 114 to the first water pump 115. The second branch 118 may be disposed at a part of the pipe 116a connecting the first branch 117 to the first radiator 114. The bypass circuit 112 is a circuit connecting the first branch 117 to the second branch 118 with a pipe 119. The bypass circuit 112 includes the first reserve tank 10. The first reserve tank 10 reserves the cooling water circulating through the engine cooling circuit 110 and absorbs a volumetric change, in response to a temperature change, of the cooling water circulating through the engine cooling circuit 110.

The auxiliary machine cooling circuit 120 is a circuit annually connecting between the intercooler as the auxiliary machine 3 of the vehicle, a second radiator 122, a second water pump 123, and the second reserve tank 20 with a pipe 124. The second radiator 122 is a heat exchanger to exchange heat between the cooling water and an outside air. The second water pump 123 circulates the cooling water through the auxiliary machine cooling circuit 120. The second reserve tank 20 reserves the cooling water circulating through the auxiliary machine cooling circuit 120 and absorbs a volumetric change, in response to a temperature change, of the cooling water circulating through the auxiliary machine cooling circuit 120. When the second water pump 123 is operated, the cooling water circulates through the auxiliary machine cooling circuit 120 and is heated by absorbing heat of an intake air compressed by a super charger (not shown) upon flowing through the intercooler. The cooling water is cooled by releasing heat to an air drawn into the engine compartment upon flowing through the second radiator 122. Such circulation of the cooling water cools the intake air and improves a charging efficiency of the intake air into the internal combustion engine 2.

The auxiliary machine 3 that is a cooling target of the auxiliary machine cooling circuit 120 is not limited to the intercooler and may be an inverter or a battery mounted in an electric vehicle or a hybrid vehicle. In this case, the auxiliary machine cooling circuit 120 is used as a cooling circuit through which the cooling water circulates to an inverter cooler or a battery cooler.

Next, the reserve tank device 1 will be described. The reserve tank device 1 is disposed in both the engine cooling circuit 110 and the auxiliary machine cooling circuit 120 described above and configures a part of the cooling system 100. The reserve tank device 1 includes the first reserve tank 10, the second reserve tank 20, the gas-liquid separator 30, and the passage switching member 40.

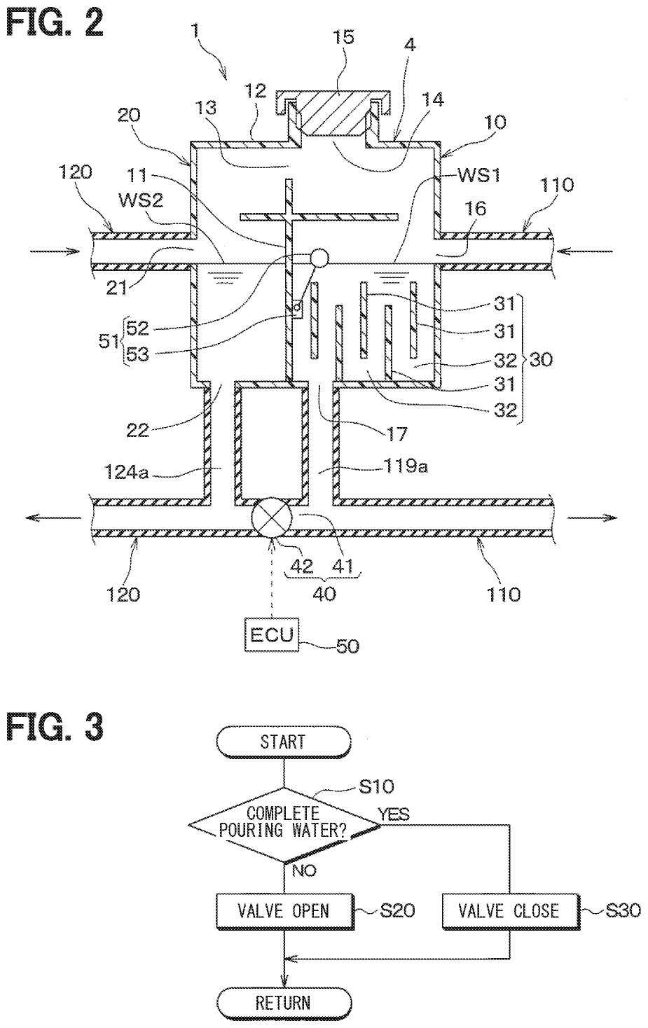

As shown in FIG. 2, the first reserve tank 10 and the second reserve tank 20 are integrally formed with each other with a resin such as polypropylene to constitute a single reserve tank 4. The single reserve tank 4 includes a partition 11 that separates the single reserve tank 4 into the first reserve tank 10 and the second reserve tank 20. The cooling water in the first reserve tank 10 is not mixed with the cooling water in the second reserve tank 20. The partition 11 is distanced from an upper wall 12 of both the first reserve tank 10 and the second reserve tank 20. That is, the single reserve tank 4 defines an opening 13 through which a gas flows between the partition 11 and the upper wall 12 of both the first reserve tank 10 and the second reserve tank 20. Thus, a pressure in the engine cooling circuit 110 is substantially the same as a pressure in the auxiliary machine cooling circuit 120.

The single reserve tank 4 includes a cooling water inlet 14 through which the cooling water is supplied into the single reserve tank 4. The cooling water inlet 14 is covered with a cap 15. The single reserve tank 1 includes only a single pair of the cooling water inlet 14 and the cap 15. Concretely, the single pair of the cooling water inlet 14 and the cap 15 is disposed in an upper portion of the first reserve tank 10. The cap 15 is attachable to and detachable from the cooling water inlet 14 with a screw or an engagement therebetween. The cap 15 can open and close the cooling water inlet 14. The cap 15 may include a pressure regulating valve (not shown) therein to regulate the pressure in the engine cooling circuit 110 and the auxiliary machine cooling circuit 120. A positions of the single pair of the cooling water inlet 14 and the cap 15 is not limited to the upper portion of the first reserve tank 10 and may be an upper portion of the second reserve tank 20.

The first reserve tank 10 includes a first inlet 16 through which the cooling water flows into the first reserve tank 10 from the engine cooling circuit 110 and a first outlet 17 through which the cooling water flows out of the first reserve tank 10 to the engine cooling circuit 110. The second reserve tank 20 includes a second inlet 21 through which the cooling water flows into the second reserve tank 20 from the auxiliary machine cooling circuit 120 and a second outlet 22 through which the cooling water flows out of the second reserve tank 20 to the auxiliary machine cooling circuit 120.

FIG. 2 illustrates examples of a water level WS1 of the cooling water in the first reserve tank 10 and a water level WS2 of the cooling water in the second reserve tank 20, but the water levels WS1 and WS2 are not limited to the examples. In FIG. 2, the water level WS1 of the cooling water in the first reserve tank 10 is the same as the water level WS2 of the cooling water in the second reserve tank 20. However, the water level WS1 and the water level WS2 may be different when a valve 42 described later is closed. In FIG. 2, the water level WS1 of the cooling water in the first reserve tank 10 is located at a position lower side of the first inlet 16, but the water level WS1 may be located at a position middle or upper side of the first inlet 16. In FIG. 2, the water level WS2 of the cooling water of the second reserve tank 20 is located at a lower side of the second inlet 21, but the water level WS2 may be a middle or upper side of the second inlet 21.

The first reserve tank 10 includes the gas-liquid separator 30 therein. The gas-liquid separator 30 is configured with multiple partitions 31 that separates an inner space of the first reserve tank 10 into multiple rooms and multiple holes 32 that are defined by the multiple partitions 31. The multiple rooms are fluidly connected with each other through the multiple holes 32. In this way, the gas-liquid separator 30 forms a labyrinth configuration in the first reserve tank 10 to separate bubbles in the cooling water flowing through the first reserve tank 10.

A configuration of the gas-liquid separator 30 is not limited to the labyrinth configuration including the multiple partitions 31 and the multiple holes 32 as described above and may be a spiral flow configuration such as a swirl or cyclone.

The gas-liquid separator 30 is not disposed in the second reserve tank 20. This does not mean that the second reserve tank 20 is prohibited to have the gas-liquid separator. The gas-liquid separator may be disposed in both the first reserve tank 10 and the second reserve tank 20 such that an area occupied by the gas-liquid separator in the second reserve tank 20 is smaller than an area occupied by the gas-liquid separator in the first reserve tank 10. That is, if the gas-liquid separator 30 is disposed in both the first reserve tank and the second reserve tank 20, it is preferable that the area occupied by the gas-liquid separator in the second reserve tank 20 is smaller than that in the first reserve tank 10.

The passage switching member 40 is configured with a connecting passage 41, the valve 42 and the like. The passage switching member 40 is configured to selectively allow and forbid the cooling water to flow between the engine cooling circuit 110 and the auxiliary machine cooling circuit 120. The connecting passage 41 connects the pipe 119a extending from the first outlet 17 of the first reserve tank 10 in a downstream direction of the cooling water to the pipe 124a extending from the second outlet 22 of the second reserve tank 20 in the downstream direction. The valve 42 is disposed in the connecting passage 41. In the first embodiment, the valve 42 is an on-off valve. When the valve 42 is closed, the cooling water is forbidden to flow through the connecting passage 41. When the valve 42 is opened, the cooling water is allowed to flow through the connecting passage 41.

An operation of the valve 42 in the passage switching member 40 is controlled by a controller 50. The controller 50 is configured with a processor executing a controlling process and a calculating process, a ROM memorizing a program and data, a microcomputer including a memory such as a RAM, and peripheral circuits. The controller 50 includes a data logger or the like serving as a memory.

The valve 42 may be configured to be manually operated by a person. The valve 42 may be configured to be operated with an opening-closing switch (not shown) manually operated by a person.

The first reserve tank 10 includes a liquid level detecting device 51. The liquid level detecting device 51 includes a float 52 floating on a water surface of the first reserve tank 10 and a signal outputting portion 53 configured to output signals according to a position of the float 52. The signal outputting portion 53 outputs sensor signals as information on the position of the float 52. The controller 50 controls the valve 42 based on the sensor signals outputted by the signal outputting portion 53. A controlling method of the valve 42 by the controller 50 will be described later.

Next, an operation when the cooling water is supplied into the reserve tank device 1 will be described. The cooling water is supplied into the reserve tank device 1 during a manufacture of the vehicle, an inspection of the vehicle, or the like.

While the cooling water is supplied into the reserve tank device 1, the internal combustion engine 2 is stopped. At first, an operator removes the cap 15 from the cooling water inlet 14 of the first reserve tank 10 and then manually opens the valve 42. Accordingly, the cooling water flows through the connecting passage 41 between the engine cooling circuit 110 and the auxiliary machine cooling circuit 120.

Next, the operator supplies the cooling water into the first reserve tank 10 through the cooling water inlet 14 of the first reserve tank 10. Thus, the cooling water is supplied into the engine cooling circuit 110 from the first reserve tank 10 and then into the auxiliary machine cooling circuit 120 from the engine cooling circuit 110 through the connecting passage 41. The gas-liquid separator removes bubbles generated when the cooling water is supplied into the first reserve tank 10 through the cooling water inlet 14. Therefore, the cooling water without bubbles is supplied into both the engine cooling circuit 110 and the auxiliary machine cooling circuit 120. That is, the reserve tank device 1 can commonly use the gas-liquid separator disposed in the first reserve tank 10 when the cooling water is supplied into both the engine cooling circuit 110 and the auxiliary machine cooling circuit 120.

As described above, the water level WS1 (i.e., a height of a water surface) of the first reserve tank 10 is detected by the liquid level detecting device 51 and sensor signals are transmitted to the controller 50. The controller 50 controls the operation of the valve 42 based on the sensor signals transmitted by the liquid level detecting device 51. An example of a controlling process in which the controller 50 operates the valve 42 will be described with a flow chart in FIG. 3.

The controlling process may be started when the operator starts to supply the cooling water. When the operator starts to supply the cooling water may be detected with sensor signals transmitted by the liquid level detecting device 51. Alternatively, the controlling process may be started when the operator manually opens the valve 42 or the cap 15, or when an ignition switch of the vehicle is switched off.

At step S10, the controller 50 determines whether it is completed to supply the cooling water or not. Specifically, the controller 50 detects the water level in the first reserve tank 10 based on the sensor signals transmitted by the liquid level detecting device 51. When the controller 50 determines that the water level in the first reserve tank 10 is lower than a predetermined level, the process proceeds to step S20. In this case, it is not completed to supply the cooling water into the reserve tank device 1.

At step S20, the controller 50 keeps the valve 42 open. Accordingly, the cooling water flows through the connecting passage 41 between the engine cooling circuit 110 and the auxiliary machine cooling circuit 120 and the operator can continue supplying the cooling water. The controller 50 repeats the process from step S10.

In contrast, when the controller 50 determines that the water level in the first reserve tank 10 is equal to or greater than the predetermined level at step S10, the process proceeds to step S30. In this case, an appropriate amount of the cooling water is supplied into both the engine cooling circuit 110 and the auxiliary machine cooling circuit 120 and it is completed to supply the cooling water.

At step S30, the controller 50 closes the valve 42 and the cooling water is thereby forbidden to flow through the connecting passage 41 between the engine cooling circuit 110 and the auxiliary machine cooling circuit 120. The operator stops supplying the cooling water into the first reserve tank 10 and attaches the cap 15 to the cooling water inlet 14 of the reserve tank device 1.

After that, the ignition switch of the vehicle is switched on to operate the internal combustion engine 2, and then the cooling water circulates separately through the engine cooling circuit 110 and the auxiliary machine cooling circuit 120. The cooling water circulating through the engine cooling circuit 110 are not mixed with the cooling water circulating through the auxiliary machine cooling circuit 120.

During the operation of the internal combustion engine 2, bubbles may be generated in the cooling water circulating through the engine cooling circuit 110 due to local boiling. The bubbles are removed from the cooling water by the gas-liquid separator 30 disposed in the first reserve tank 10 while the cooling water is flowing in the first reserve tank 10. In contrast, bubbles are rarely generated in the cooling water circulating through the auxiliary machine cooling circuit 120. Thus, the gas-liquid separator 30 is not necessarily disposed in the second reserve tank 20 or an area occupied by the gas-liquid separator 30 in the second reserve tank can be reduced. Therefore, the reserve tank device 1 can downsize the second reserve tank 20 and reduce a pressure loss of the cooling water circulating through the auxiliary machine cooling circuit 120.

The reserve tank device 1 and the cooling system 100 of the present disclosure described above have the following advantages.

(1) In the reserve tank device 1 of this embodiment, the passage switching member 40 can selectively allow and forbid the cooling water to flow between the engine cooling circuit 110 and the auxiliary machine cooling circuit 120. The first reserve tank 10 includes the gas-liquid separator 30. Accordingly, when the cooling water is supplied into the first reserve tank 10 in a state where the passage switching member 40 allows the cooling water to flow between the engine cooling circuit 110 and the auxiliary machine cooling circuit 120, the cooling water can be supplied into both the engine cooling circuit 110 and the auxiliary machine cooling circuit 120. The gas-liquid separator 30 removes bubbles generated when the cooling water is supplied and thus, the cooling water without bubbles is supplied into both the engine cooling circuit 110 and the auxiliary machine cooling circuit 120. Therefore, the reserve tank device 1 can commonly use the gas-liquid separator 30 disposed in the first reserve tank 10 when the cooling water is supplied into both the engine cooling circuit 110 and the auxiliary machine cooling circuit 120. The gas-liquid separator 30 is not necessarily disposed in the second reserve tank 20 or may be disposed in both the first reserve tank and the second reserve tank such that an area occupied by the gas-liquid separator is small.

When the passage switching member 40 is operated to forbid the cooling water to flow between the engine cooling circuit 110 and the auxiliary machine cooling circuit 120, the cooling water circulating through the engine cooling circuit 110 is not mixed with the cooling water circulating through the auxiliary machine cooling circuit 120. The gas-liquid separator 30 disposed in the first reserve tank 10 removes bubbles generated in the engine cooling circuit 110 when the internal combustion engine 2 is operated. In contrast, bubbles are rarely generated in the cooling water circulating through the auxiliary machine cooling circuit 120. Therefore, the gas-liquid separator 30 is not necessarily disposed in the second reserve tank 20 or may be disposed in the second reserve tank such that an area occupied by the gas-liquid separator is small. Therefore, the second reserve tank 20 can be downsized and the pressure loss of the cooling water circulating through the auxiliary machine cooling circuit 120 can be reduced.

(2) In this embodiment, the gas-liquid separator 30 is not disposed in the second reserve tank 20, or the gas-liquid separator 30 is disposed in both the first reserve tank 10 and the second reserve tank 30 such that the area occupied by the gas-liquid separator 30 in the second reserve tank 20 is smaller than that in the first reserve tank 10. Thus, the reserve tank device 1 can downsize the second reserve tank 20 and reduce the pressure loss of the cooling water circulating through the auxiliary machine cooling circuit 120.

(3) In this embodiment, the single reserve tank 4 includes only the single pair of the cooling water inlet 14 and the cap 15. Accordingly, when the cooling water is supplied into both the engine cooling circuit 110 and the auxiliary machine cooling circuit 120, the cooling water inlet 14 can be commonly used. Thus, the single reserve tank 4 can be downsized and a manufacturing cost can be reduced.

(4) In this embodiment, the cooling water inlet 14 and the cap 15 are located in an upper portion of the first reserve tank 10. Accordingly, when the cooling water is supplied into both the engine cooling circuit 110 and the auxiliary machine cooling circuit 120, the gas-liquid separator 30 disposed in the first reserve tank 10 can be commonly used.

(5) In this embodiment, the passage switching member 40 includes the connecting passage 41 fluidly connecting the engine cooling circuit 110 to the auxiliary machine cooling circuit 120 and the valve 42 disposed in the connecting passage 41. The valve 42 may be an on-off valve.

(6) In this embodiment, the reserve tank device 1 further includes the liquid level detecting device 51 and the controller 50. The liquid level detecting device 51 is disposed in the first reserve tank 10. The controller 50 controls the valve 42 to be closed upon determining, based on the signals transmitted by the liquid level detecting device 51, that the amount of the cooling water in the first reserve tank 10 is equal to or greater than the predetermined value. Accordingly, when it is completed to supply the cooling water into both the engine cooling circuit 110 and the auxiliary machine cooling circuit 120, the controller 50 operates the passage switching member 40 to forbid the cooling water to flow between the engine cooling circuit 110 and the auxiliary machine cooling circuit 120.

(7) In this embodiment, the auxiliary machine cooling circuit 120 is used for the water cooling type intercooler. The auxiliary machine cooling circuit 120 may be used for the inverter cooler or the battery cooler mounted in an electric vehicle or a hybrid vehicle. In this case, bubbles are rarely generated in the cooling water circulating through the auxiliary machine cooling circuit 120. Thus, the gas-liquid separator is not necessarily disposed in the second reserve tank 20 or may be disposed in the second reserve tank such that the area occupied by the gas-liquid separator is small.

(8) The reserve tank device 1 in this embodiment forms the cooling system 100 with the engine cooling circuit 110 and the auxiliary machine cooling circuit 120. Accordingly, the cooling system 100 can commonly use the gas-liquid separator 30 disposed in the first reserve tank and thus, the gas-liquid separator is not necessarily disposed in the second reserve tank 20 or may be disposed in the second reserve tank such that the area occupied by the gas-liquid separator is small. Therefore, the cooling system 100 can downsize the second reserve tank 20 and reduce the pressure loss of the cooling water circulating through the auxiliary machine cooling circuit 120.

### Second Embodiment

A second embodiment will be described. The second embodiment differs from the first embodiment at a configuration of the passage switching member 40 and other parts are similar to the first embodiment. Thus, different portions from the first embodiment will be mainly described.

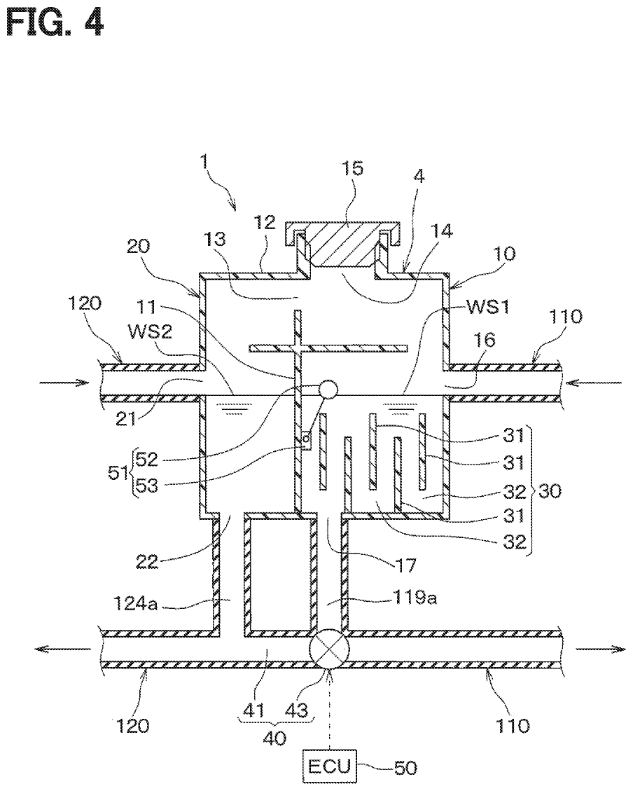

As shown in FIG. 4, in the second embodiment, the passage switching member 40 is configured with the connecting passage 41 and a valve 43. The connecting passage 41 fluidly connects the pipe 119a extending from the first outlet 17 of the first reserve tank 10 in the downstream direction to the pipe 124a extending from the second outlet 22 of the second reserve tank 20 in the downstream direction. The valve 43 is disposed at a connecting point between the engine cooling circuit 110 and the connecting passage 41. In the second embodiment, the valve 43 is a three-way valve. The valve 43 can selectively allow and forbid the cooling water to flow between the engine cooling circuit 110 and the connecting passage 41. Accordingly, the valve 43 can selectively allow and forbid the cooling water to flow between the engine cooling circuit 110 and the auxiliary machine cooling circuit 120.

In the second embodiment described above, the similar advantages as with the first embodiment can be obtained. When the valve 43 is a three-way valve like the second embodiment, the valve 43 may be disposed at the connecting point between the auxiliary machine cooling circuit 120 and the connecting passage 41.

### Third Embodiment

A third embodiment will be described. The third embodiment differs from the first embodiment at a configuration of the reserve tank. Other portions are similar to the first embodiment and the different portions from the first embodiment will be mainly explained.

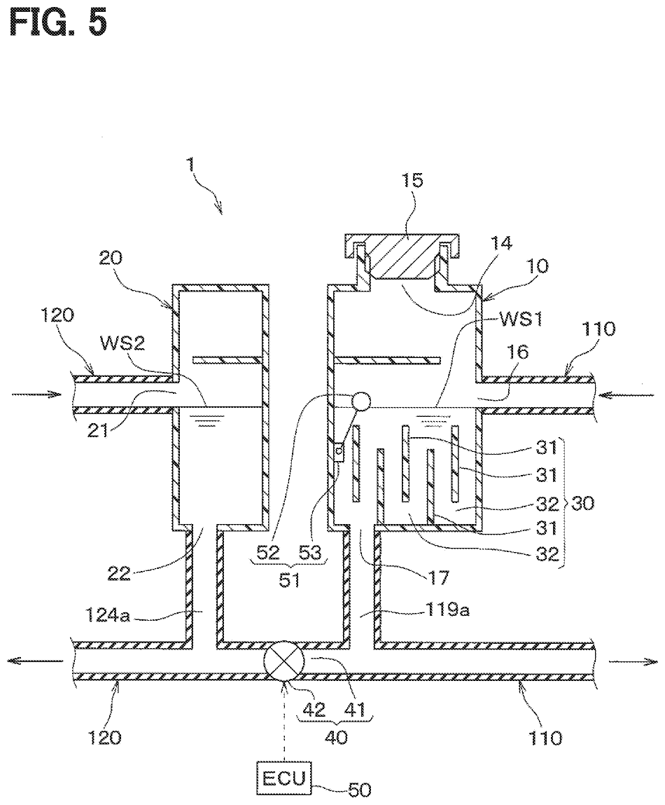

As shown in FIG. 5, the first reserve tank 10 and the second reserve tank 20 are different members with each other in the third embodiment. The first reserve tank 10 includes the cooling water inlet 14 through which the cooling water is supplied into the first reserve tank 10. The cap 15 is attached to the cooling water inlet 14. The second reserve tank 20 does not include a cooling water inlet through which the cooling water is supplied into the second reserve tank 20. The second reserve tank 20 may have the cooling water inlet.

The first reserve tank 10 includes the gas-liquid separator 30 therein. The gas-liquid separator 30 forms the labyrinth configuration in the first reserve tank 10 and separates bubbles in the cooling water flowing through the first reserve tank 10 from the cooling water. In contrast, the second reserve tank 20 does not include the gas-liquid separator 30 therein. This does not mean that the second reserve tank 20 must not have the gas-liquid separator 30. The second reserve tank 20 may have the gas-liquid separator 30 such that the area occupied by the gas-liquid separator 30 in the second reserve tank 20 is smaller than that in the first reserve tank 10.

In the third embodiment described above, the similar advantages as with the first embodiment can be obtained.

### Fourth Embodiment

A fourth embodiment will be described. The fourth embodiment is different from the first embodiment at the configuration of the passage switching member 40. Other portions are similar to the first embodiment, thus different portions from the first embodiment will be mainly described.

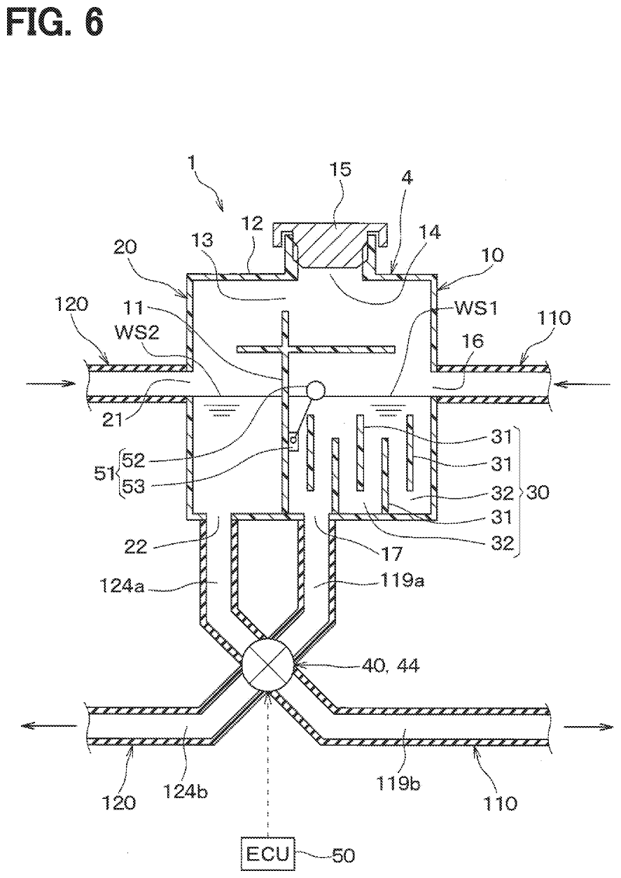

As shown in FIG. 6, in the fourth embodiment, the passage switching member 40 does not include the connecting passage. The passage switching member 40 is configured with a four-way valve 44. The engine cooling circuit 110 has pipes 119a and 119b that are disposed at a position downstream side of the first outlet 17 of the first reserve tank 10. The auxiliary machine cooling circuit 120 has pipes 124a and 124b that are disposed at a downstream side of the second outlet 22 of the second reserve tank 20. The four-way valve 44 connects the pipes 119a and 119b of the engine cooling circuit 110 to the pipes 124a and 124b of the auxiliary machine cooling circuit 120. The four-way valve 44 switches between a state in which the cooling water is prohibited to flow between the engine cooling circuit 110 and the auxiliary machine cooling circuit 120 and a state in which the cooling water is allowed to flow between the engine cooling circuit 110 and the auxiliary machine cooling circuit 120. In the fourth embodiment described above, the similar advantages are obtained as with the first embodiment.

### Fifth to Eights Embodiment

In the first to fourth embodiments described above, the internal combustion engine 2 and the auxiliary machine 3 of the vehicle are cooling targets that are cooled by the cooling water circulating through the cooling circuits. In the following fifth to eighth embodiments, multiple auxiliary machines mounted in the vehicle are cooled by multiple cooling circuits.

### Fifth Embodiment

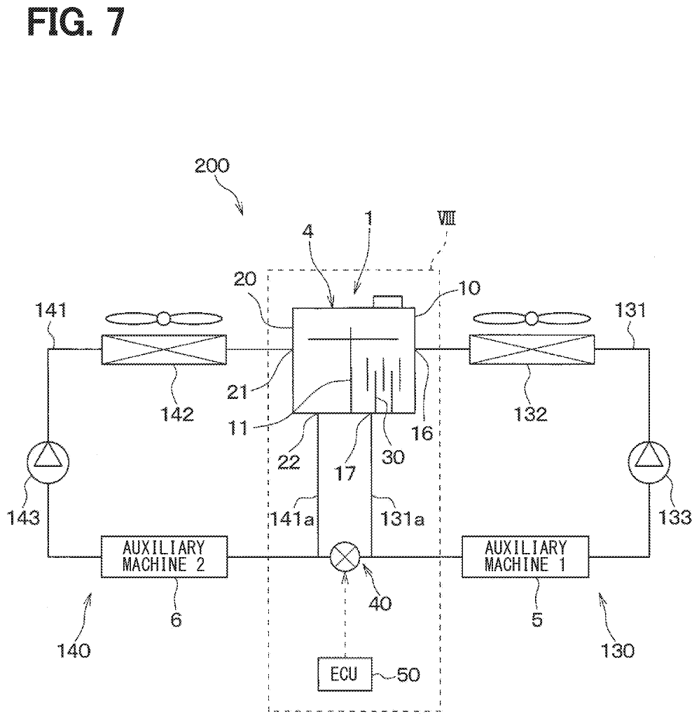

As shown in FIG. 7, in a fifth embodiment, a reserve tank device 1 is mounted in a cooling system 200 in the vehicle. The cooling system 200 includes a first auxiliary machine cooling circuit 130, a second auxiliary machine cooling circuit 140, and the reserve tank device 1.

The first auxiliary machine cooling circuit 130 is a cooling circuit through which a cooling water for a first auxiliary machine 5 of the multiple auxiliary machines mounted in the vehicle circulates. The second auxiliary machine cooling circuit 140 is a cooling circuit through which a cooling water for a second auxiliary machine 6 of the multiple auxiliary machines mounted in the vehicle circulates. In the fifth embodiment, each of the auxiliary machines 5 and 6 may be an intercooler, an inverter, or a battery.

A configuration of the first auxiliary machine cooling circuit 130 will be described.

The first auxiliary machine cooling circuit 130 is a circuit annually connecting between the first auxiliary machine 5, a first auxiliary machine radiator 132, a first auxiliary machine water pump 133, and a first reserve tank 10 of the vehicle with a pipe 131. The first auxiliary machine radiator 132 is a heat exchanger exchanging heat between the cooling water and an air. The first auxiliary machine water pump 133 circulates the cooling water through the first auxiliary machine cooling circuit 130. The first reserve tank 10 reserves the cooling water circulating through the first auxiliary machine cooling circuit 130 and absorbs a volumetric change, caused by a temperature change, of the cooling water circulating through the first auxiliary machine cooling circuit 130.

A configuration of the second auxiliary machine cooling circuit 140 will be described.

The second auxiliary machine cooling circuit 140 is a circuit annually connecting between the second auxiliary machine 6, a second auxiliary machine radiator 142, a second auxiliary machine water pump 143, and the second reserve tank 20 of the vehicle with a pipe 141. The second auxiliary machine radiator 142 is a heat exchanger exchanging heat between the cooling water and an air. The second auxiliary machine water pump 143 circulates the cooling water through the second auxiliary machine cooling circuit 140. The second reserve tank 20 reserves the cooling water circulating through the second auxiliary machine cooling circuit 140 and absorbs a volumetric change, caused by a temperature change, of the cooling water circulating through the second auxiliary machine cooling circuit 140.

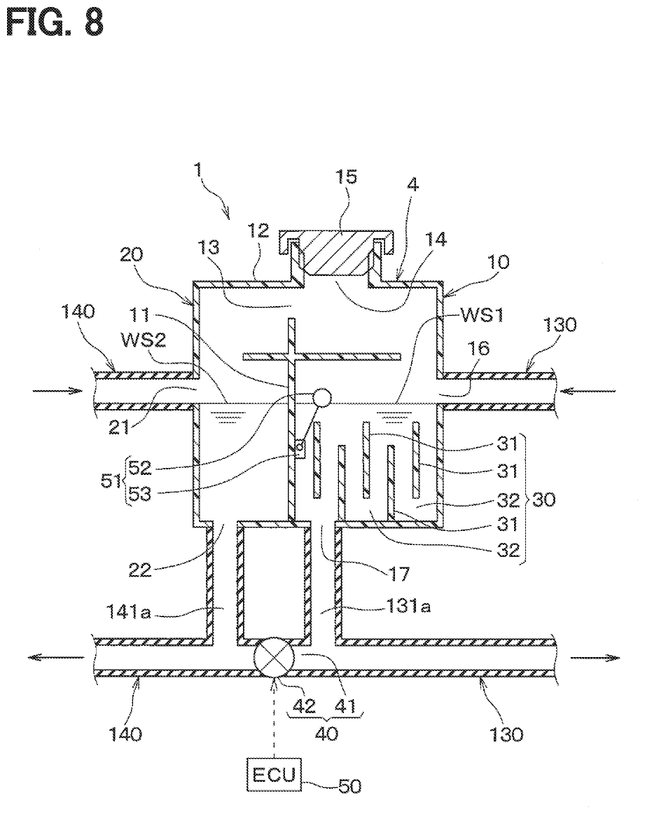

Next, the reserve tank device 1 will be described. As shown in FIGS. 7 and 8, the reserve tank device 1 is disposed in both the first auxiliary machine cooling circuit 130 and the second auxiliary machine cooling circuit 140 and constitute a part of the cooling system 200. The reserve tank device 1 reserves the cooling water circulating through the first auxiliary machine cooling circuit 130 and the second auxiliary machine cooling circuit 140. The reserve tank device 1 is the same as the one described in the first embodiment and includes the first reserve tank 10, the second reserve tank 20, the gas-liquid separator 30, and the passage switching member 40. A configuration of the reserve tank device 1 is substantially the same with the one described in the first embodiment, thus the detail descriptions are omitted.

The passage switching member 40 is configured with a connecting passage 41 and a valve 42. The passage switching member 40 can selectively allow and forbid the cooling water to flow between the first auxiliary machine cooling circuit 130 and the second auxiliary machine cooling circuit 140. The connecting passage 41 is a pipe that fluidly connects a pipe 131a extending from the first outlet 17 of the first reserve tank 10 in the downstream direction to a pipe 141a extending from the second outlet 22 of the second reserve tank 20 in the downstream direction. The valve 42 is disposed at a middle part of the connecting passage. In the fifth embodiment, the valve 42 is an on-off valve. When the valve 42 is closed, the cooling water is prohibited to flow through the connecting passage 41. When the valve 42 is opened, the cooling water is allowed to flow through the connecting passage 41.

The controller 50 controls the operation of the valve 42. A controlling method of the controller 50 is similar to the one described in the first embodiment. The valve 42 may be manually operated by a person. The valve 42 may be operated by operating an opening-closing switch (not shown).

When the auxiliary machine 5 cooled by the first auxiliary machine cooling circuit 130 is a battery mounted in an electric vehicle or a hybrid vehicle, bubbles may be generated in the cooling water circulating through the first auxiliary machine cooling circuit 130. The bubbles can be removed from the cooling water by the gas-liquid separator 30 disposed in the first reserve tank 10 while the cooling water is flowing through the first reserve tank 10. Thus, the reserve tank device 1 can remove the gas-liquid separator 30 in the second reserve tank 20 or reduce a size of the gas-liquid separator 30 in the second reserve tank 20 while the first reserve tank 10 includes the gas-liquid separator 30. Accordingly, the reserve tank device 1 can downsize the second reserve tank 20 and reduce a pressure loss of the cooling water circulating through the second auxiliary machine cooling circuit 140.

The reserve tank device 1 and the cooling system 200 in the fifth embodiment described above have the following advantages.

In the reserve tank device 1 in the fifth embodiment, the passage switching member 40 can selectively allow and forbid the cooling water to flow between the first auxiliary machine cooling circuit 130 and the second auxiliary machine cooling circuit 140. The first reserve tank 10 includes the gas-liquid separator 30. When the cooling water is supplied into the first reserve tank 10 in a state in which the passage switching member 40 allows the cooling water to flow between the first auxiliary machine cooling circuit 130 and the second auxiliary machine cooling circuit 140, the cooling water is supplied into both the first auxiliary machine cooling circuit 130 and the second auxiliary machine cooling circuit 140. In this case, the gas-liquid separator 30 removes bubbles generated in the cooling water when the cooling water is supplied into the first reserve tank 10. Thus, cooling water without bubbles is supplied into both the first auxiliary machine cooling circuit 130 and the second auxiliary machine cooling circuit 140. When the cooling water is supplied into both the first auxiliary machine cooling circuit 130 and the second auxiliary machine cooling circuit 140, the reserve tank device 1 can commonly use the gas-liquid separator 30 in the first reserve tank 10. Accordingly, the gas-liquid separator 30 is not necessarily disposed in the second reserve tank 20 or may be disposed in the second reserve tank such that an area occupied by the gas-liquid separator 30 is small. Therefore, the reserve tank device 1 can be downsized and reduce a pressure loss of the cooling water circulating through the second auxiliary machine cooling circuit 140.

When the passage switching member 40 forbids the cooling water to flow between the first auxiliary machine cooling circuit 130 and the second auxiliary machine cooling circuit 140, the cooling water circulating through the first auxiliary machine cooling circuit 130 and the cooling water circulating through the second auxiliary machine cooling circuit 140 are not mixed with each other. Thus, the temperature of the cooling water circulating through the first auxiliary machine cooling circuit 130 can be set to be different from the temperature of the cooling water circulating through the second auxiliary machine cooling circuit 140. Thus, the first auxiliary machine 5 cooled by the first auxiliary machine cooling circuit 130 and the second auxiliary machine 6 cooled by the second auxiliary machine cooling circuit 140 can be cooled at different desired temperatures.

The reserve tank device 1 and the cooling system 200 in the fifth embodiment have the similar advantages to the reserve tank device 1 and the cooling system 100 described in the first embodiment.

### Sixth Embodiment

A sixth embodiment will be described. The sixth embodiment differs from the fifth embodiment at a configuration of a passage switching member 40. Other portions are similar to the fifth embodiment, thus the different portions from the fifth embodiment will be mainly described.

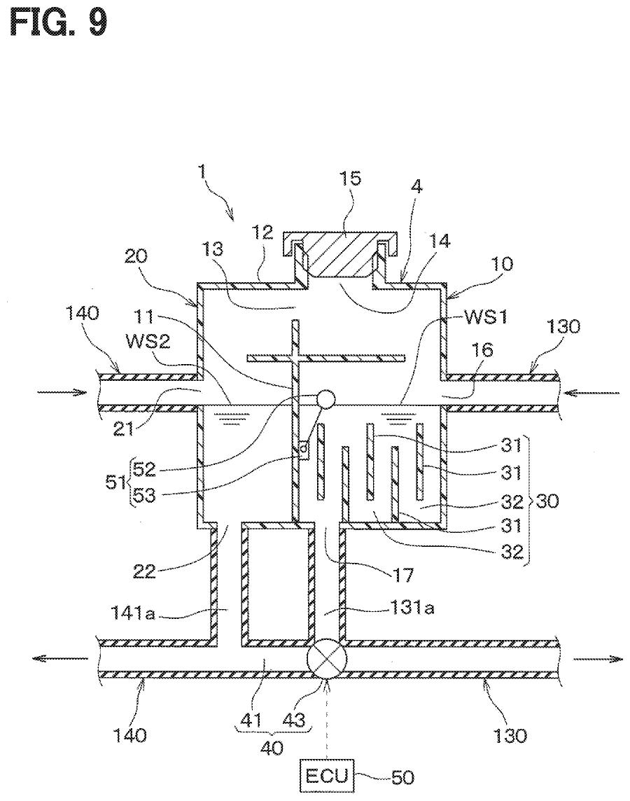

As shown in FIG. 9, in the sixth embodiment, the passage switching member 40 is configured with a connecting passage 41 and a valve 43. The connecting passage 41 connects a pipe 131a extending from the first outlet 17 of the first reserve tank 10 in the downstream direction to a pipe 141a extending from the second outlet 22 of the second reserve tank 20 in the downstream direction. The valve 43 is disposed at a connecting point between the first auxiliary machine cooling circuit 130 and the connecting passage 41. In the sixth embodiment, the valve 43 is a three-way valve. The valve 43 selectively allows and forbids the cooling water to flow between the first auxiliary machine cooling circuit 130 and the connecting passage 41. That is, the valve 43 selectively allows and forbids the cooling water to flow between the first auxiliary machine cooling circuit 130 and the second auxiliary machine cooling circuit 140.

In the sixth embodiment described above, the similar advantages to the first embodiment can be obtained. When the valve 43 is a three-way valve as with the sixth embodiment, the valve 43 may be disposed at a connecting point between the second auxiliary machine cooling circuit 140 and the connecting circuit 41.

### Seventh Embodiment

A seventh embodiment will be described. The seventh embodiment is different from the fifth embodiment at a configuration of a reserve tank. Other portions are similar with the fifth embodiment, thus different portions from the fifth embodiment will be mainly described.

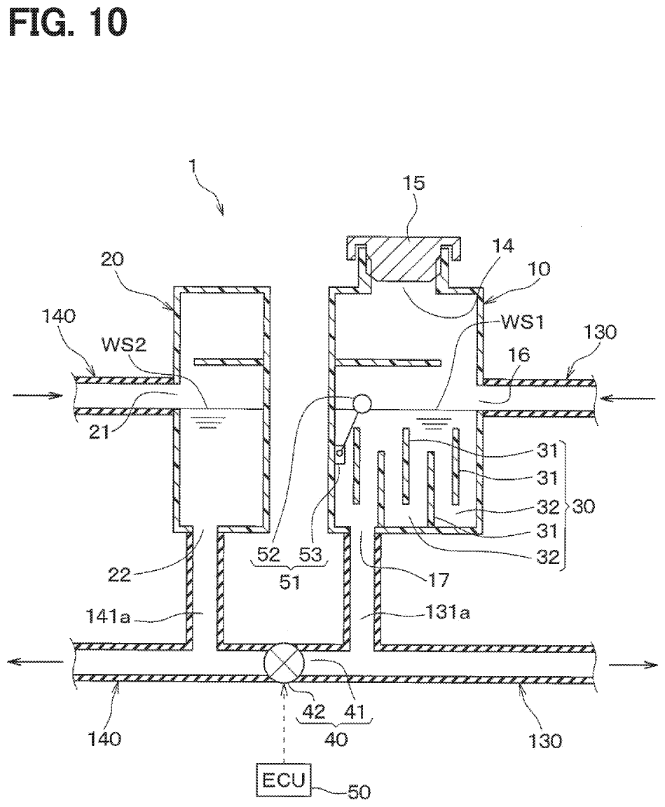

As shown in FIG. 10, in the seventh embodiment, the first reserve tank 10 and the second reserve tank 20 are formed as different members. The first reserve tank 10 includes the cooling water inlet 14 through which the cooling water is supplied into the reserve tank device 1. The cap 15 is attached to the cooling water inlet 14. The second reserve tank 20 does not include a cooling water inlet through which the cooling water is supplied into the reserve tank device 1. The second reserve tank 20 may have the cooling water inlet.

The first reserve tank 10 includes the gas-liquid separator 30 therein. The gas-liquid separator 30 has a labyrinth configuration in the first reserve tank 10 and removes bubbles in the cooling water flowing through the first reserve tank 10. The second reserve tank 20 does not include the gas-liquid separator 30 therein. This does not mean that the second reserve tank 20 is forbidden to have the gas-liquid separator 30. The gas-liquid separator 30 may be disposed in both the first reserve tank and the second reserve tank 20 such that an area occupied by the gas-liquid separator 30 is smaller than that in the first reserve tank 10.

In the seventh embodiment described above, similar advantages with the first embodiment can be obtained.

### Eighth Embodiment

An eighth embodiment will be described. The eighth embodiment is different from the fifth embodiment at a configuration of the passage switching member 40 and other parts are similar with the fifth embodiment. Thus, different portions from the fifth embodiment will be mainly described.

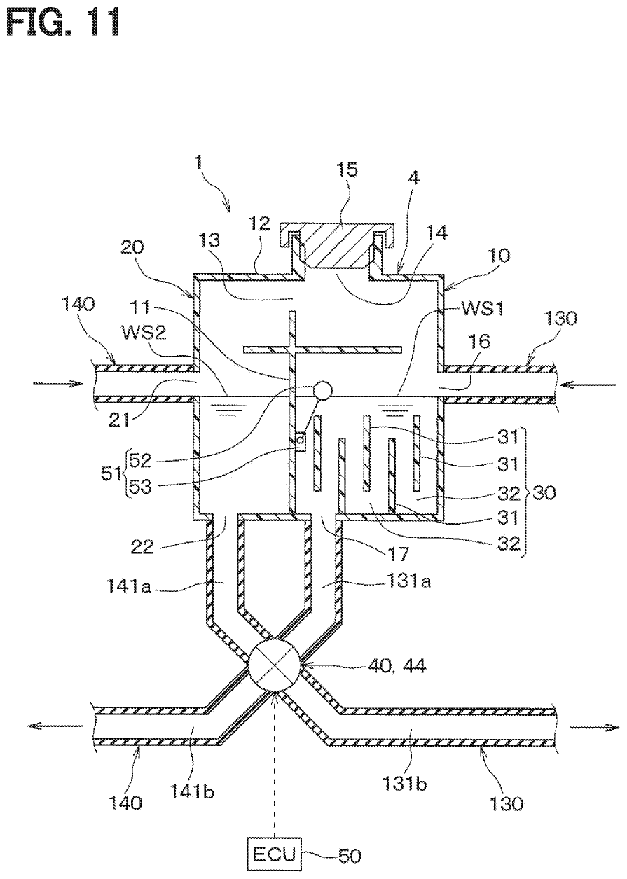

As shown in FIG. 11, in the eighth embodiment, the passage switching member 40 is configured with a four-way valve 44 without a connecting passage. The first auxiliary machine cooling circuit 130 includes pipes 131a and 131b located at a position downstream side of the first outlet 17 of the first reserve tank 10. The second auxiliary machine cooling circuit 120 includes pipes 141a and 14b located at a downstream side of the second outlet 22 of the second reserve tank 20. The four-way valve 33 connects the pipes 131a and 131b of the first auxiliary machine cooling circuit 130 to the pipes 141a and 141b of the second auxiliary machine cooling circuit 140. The four-way valve 33 selectively allows and forbids the cooling water to flow between the first auxiliary machine cooling circuit 130 and the second auxiliary machine cooling circuit 140. In the eighth embodiment described above, the similar advantages with the first embodiment can be obtained.

### Other Embodiments

The present disclosure is not limited to the above mentioned embodiments and may be altered appropriately. The above embodiments are related with each other and may be combined with each other appropriately unless the combination is apparently impossible. In the above embodiments, elements of the embodiments are not always necessary unless the elements are described to be necessary or necessary in principle. In addition, in case that numeral values such as the number, value, amount, range of the element are mentioned, the elements are not limited to the numeral values unless the elements are described to be limited to the numeral values or apparently limited to the numeral values in principle. In case that shapes and positional relationships are mentioned in the above embodiments, the elements are not limited to the shapes and positional relationships unless the embodiments are described to be limited to the specified shapes and positional relationships or limited to the specified shapes and positional relationship in principle.

The controller and the controlling method thereof disclosed in the present disclosure may be performed by an exclusive computer provided with a processor and a memory programmed to execute one or multiple functions embodied by a computer program. Alternatively, the controller and the controlling method thereof disclosed in the present disclosure may be performed by an exclusive computer provided with a processor with at least one exclusive hardware logic circuit. Alternatively, the controller and the controlling method thereof may be performed by at least one computer configured with a combination with a processor and a memory programmed to execute one or multiple functions and at least one hardware logic circuit. The computer program may be stored on a non-transitory tangible storage medium that is readable by a computer as an instruction executed by the computer.

(1) In the above embodiments, while the cooling water is supplied into the reserve tank device, the controller 50 determines, based on sensor signals transmitted by the liquid level detecting device 51, whether it is completed to supply the cooling water and operates the valve 42, 43, or 44. However, in other embodiments, the controller 50 may operate the valve 42, 43, or 44 to forbid the cooling water to flow between the engine cooling circuit 110 and the auxiliary machine cooling circuit 120 when the vehicle is traveling. The controller 50 may operate the valve 42, 43, or 44 to forbid the cooling water to flow between the first auxiliary machine cooling circuit 130 and the second auxiliary machine cooling circuit 140 when the vehicle is traveling. The controller 50 can determine whether the vehicle is traveling or not by detecting rotation signals of a tire of the vehicle. Accordingly, the cooling water cannot flow between the engine cooling circuit 110 and the auxiliary machine cooling circuit 120 or between the first auxiliary machine cooling circuit 130 and the second auxiliary machine cooling circuit 140 when the vehicle is traveling.

(2) In the above embodiments, the controller 50 automatically operates the valves 42, 43, or 44 upon determining that it is completed to supply the cooling water. However, the present disclosure is not limited to this. In other embodiments, the valves 42, 43, or 44 may be manually operated by an operator when the cooling water is started to be supplied and stopped to be supplied. Specifically, the operator visually detects a liquid level in the first reserve tank 10 or the second reserve tank 20 with its eyes when the cooling water is started to be supplied. When the amount of the cooling water in the first reserve tank 10 or the second reserve tank 20 is equal to or greater than a predetermined value, the operator manually operates the passage switching member 40 to forbid the cooling water to flow between the engine cooling circuit 110 and the auxiliary machine cooling circuit 120 with its hands.

(3) In the above embodiments, the liquid level detecting device 51 is disposed in the first reserve tank 10, but the present disclosure is not limited to this. In other embodiments, the liquid level detecting device 51 may be disposed in the second reserve tank 20.

(4) In the above embodiments, the cooling water inlet 14 and the cap 15 are disposed at an upper portion of the first reserve tank 10, but the present disclosure is not limited to this. In other embodiments, the cooling water inlet 14 and the cap 15 may be disposed in an upper portion of the second reserve tank 20. In this case, the cooling water can be supplied into both the engine cooling circuit 110 and the auxiliary machine cooling circuit 120 through the cooling water inlet 14 and the second reserve tank 20. Alternatively, the cooling water can be supplied into both the first auxiliary machine cooling circuit 130 and the second auxiliary machine cooling circuit 140 through the cooling water inlet 14 and the second reserve tank 20.

(5) There is no limitations on materials of the reserve tank device 1, the engine cooling circuit 110, and the auxiliary machine cooling circuits 120, 130, and 140. They can be made of various materials such as resin, metal, and rubber.

### (Summary)

According to a first aspect described in a part or all parts of the above embodiments, a reserve tank device is disposed in both an engine cooling circuit through which a cooling water for cooling an internal combustion engine mounted in a vehicle circulates and an auxiliary machine cooling circuit through which a cooling water for cooling an auxiliary machine circulates. The reserve tank device includes a first reserve tank, a second reserve tank, a passage switching member, and a gas-liquid separator. The first reserve tank reserves the cooling water circulating through the engine cooling circuit. The second reserve tank reserves the cooling water circulating through the auxiliary machine cooling circuit. The gas-liquid separator is disposed in the first reserve tank and removes bubbles in the cooling water flowing through the first reserve tank.

According to a second aspect, the gas-liquid separator is not disposed in the second reserve tank or may be disposed in both the first reserve tank and the second reserve tank such that an area occupied by the gas-liquid separator in the second reserve tank is smaller than that in the first reserve tank.

The reserve tank device can commonly use the gas-liquid separator in the first reserve tank for the engine cooling circuit and the auxiliary machine cooling circuit while the cooling water is supplied into them. The gas-liquid separator is not disposed in the second reserve tank or may be disposed in both the first reserve tank and the second reserve tank such that an area occupied by the gas-liquid separator in the second reserve tank is smaller than that in the first reserve tank. Therefore, the second reserve tank can be downsized and a pressure loss of the cooling water flowing through the auxiliary cooling circuit can be reduced.

According to a third aspect, the first reserve tank and the second reserve tank are integrally formed with each other to constitute a single reserve tank. The single reserve tank includes only a single pair of a cooling water inlet through which the cooling water is supplied into the single reserve tank and a cap configured to cover the cooling water inlet.

Accordingly, the single pair of the cooling water inlet and the cap of the single reserve tank can be commonly used when the cooling water is supplied into both the engine cooling circuit and the auxiliary machine cooling circuit. Accordingly, the single reserve tank can be downsized and a manufacturing cost is reduced.

According to a fourth embodiment, the first reserve tank and the second reserve tank are integrally formed with each other to constitute a single reserve tank. The cooling water inlet through which the cooling water is supplied into the single reserve tank and the cap configured to cover the cooling water inlet are located at an upper portion of the first reserve tank.

Accordingly, when the cooling water is supplied through the cooling water inlet of the first reserve tank in a state in which the passage switching member allows the cooling water to flow between the engine cooling circuit and the auxiliary machine cooling circuit, the cooling water can be supplied into both the engine cooling circuit and the auxiliary machine cooling circuit. Thus, the reserve tank device commonly uses the cooling water inlet of the first reserve tank when the cooling water is supplied into both the engine cooling circuit and the auxiliary machine cooling circuit. Therefore, the cooling water inlet is not necessarily disposed in the second reserve tank and the second reserve tank can be downsized.

According to a fifth embodiment, the passage switching member includes a connecting passage fluidly connecting the engine cooling circuit to the auxiliary machine cooling circuit and an on-off valve disposed in the connecting passage. When the valve is disposed in the connecting passage, the valve may be an on-off valve.

According to a sixth embodiment, the passage switching member includes a connecting passage fluidly connecting the engine cooling circuit and the auxiliary machine cooling circuit and a three-way valve disposed at a connecting point between the engine cooling circuit and the connecting passage or the connecting point between the auxiliary machine cooling circuit and the connecting passage. When the valve is disposed at the connecting point between the engine cooling circuit and the connecting passage or the connecting point between the auxiliary machine cooling circuit and the connecting passage, the valve may be a three-way valve.

According to a seventh aspect, a liquid level in the first reserve tank or the second reserve tank is visually detected by an operator. When the operator detects that the amount of the cooling water in the first reserve tank or the second reserve tank is equal to or greater than a predetermined value with its eyes, the operator manually operates the passage switching member to forbid the cooling water to flow between the engine cooling circuit and the auxiliary machine cooling circuit.

According to an eighth aspect, the reserve tank device further includes a liquid level detecting device and a controller. The liquid level detecting device is disposed in the first reserve tank or the second reserve tank. The controller operates the passage switching member to forbid the cooling water to flow between the engine cooling circuit and the auxiliary machine cooling circuit upon determining, based on signals outputted from the liquid level detecting device, that the amount of the cooling water in the first reserve tank or the second reserve tank is equal to or greater than a predetermined value.

Accordingly, when it is completed to supply the cooling water into the engine cooling circuit and the auxiliary machine cooling circuit, the controller automatically operates the passage switching member to forbid the cooling water to flow between the engine cooling circuit and the auxiliary machine cooling circuit.

According to a ninth aspect, the reserve tank device includes a controller configured to operate the passage switching member to forbid the cooling water to flow between the engine cooling circuit and the auxiliary machine cooling circuit when the vehicle is traveling.

Accordingly, the controller can automatically operate the passage switching member to forbid the cooling water to flow between the engine cooling circuit and the auxiliary cooling circuit when the vehicle is travelling. The controller can determine whether the vehicle is travelling by detecting rotational signals of a tire.

According to a tenth embodiment, the auxiliary machine cooling circuit is used for a water cooling type intercooler, an inverter cooler, or a battery cooler.

A cooling target of the cooling water circulating through the auxiliary machine cooling circuit may be a supercharged intake air, an inverter, or a battery. In this case, bubbles are rarely generated in the cooling water circulating through the auxiliary machine cooling circuit. Thus, the gas-liquid separator is not necessarily disposed in the second reserve tank or may be disposed in the second reserve tank such that an area occupied by the gas-liquid separator is small.

According to an eleventh aspect, a reserve tank device is disposed in multiple auxiliary machine cooling circuits through which cooling water for cooling multiple auxiliary machines mounted in the vehicle circulates. The reserve tank device includes a first reserve tank, a second reserve tank, a passage switching member, and a gas-liquid separator. The first reserve tank reserves a cooling water circulating through a first auxiliary machine cooling circuit of the multiple auxiliary machine cooling circuits. The second reserve tank reserves a cooling water circulating through a second auxiliary machine cooling circuit of the multiple auxiliary cooling circuits. The passage switching member selectively allows and forbids the cooling water to flow between the first auxiliary machine cooling circuit and the second auxiliary cooling circuit. The gas-liquid separator is disposed in the first reserve tank and removes bubbles from the cooling water flowing through the first reserve tank.

According to a twelfth aspect, a cooling system is mounted in a vehicle and includes a reserve tank device and multiple cooling circuits. The reserve tank device has a configuration described in the above first to eleventh aspects. A cooling water, which is reserved in a first reserve tank and a second reserve tank of the reserve tank device, circulates through the multiple cooling circuits and cools an internal combustion engine or an auxiliary machine mounted in the vehicle.

The cooling system can commonly use the gas-liquid separator disposed in the first reserve tank, thus the second reserve tank may not have a gas-liquid separator or reduce an area occupied by the gas-liquid separator in the second reserve tank. Additionally, a pressure loss of the cooling water circulating through the cooling circuit through which cooling water reserved in the second reserve tank circulates can be reduced.

According to a thirteenth aspect, the gas-liquid separator of the reserve tank device in the above eleventh aspect is not disposed in the second reserve tank or may be disposed in the second reserve tank such that an area occupied by the gas-liquid separator in the second reserve tank is smaller than that in the first reserve tank.

When the cooling water is supplied into both the first auxiliary cooling circuit and the second auxiliary cooling circuit, the reserve tank device can commonly use the gas-liquid separator disposed in the first reserve tank. Thus, the gas-liquid separator is not necessarily disposed in the second reserve or may be disposed in the second reserve tank such that an area occupied by the gas-liquid separator in the second reserve tank is reduced. Therefore, the second reserve tank can be downsized and a pressure loss of the cooling water circulating through the second auxiliary machine cooling circuit can be reduced.

According to a fourteenth aspect, the first reserve tank and the second reserve tank of the reserve tank device in the above eleventh aspect are integrally formed with each other to constitute a single reserve tank. The single reserve tank includes only a single pair of a cooling water inlet through which the cooling water is supplied and a cap configured to cover the cooling water inlet.

When the cooling water is supplied into both the first auxiliary machine cooling circuit and the second auxiliary machine cooling circuit, the cooling water inlet located at one position of the single reserve tank can be used in common. Thus, the single reserve tank can be downsized and a manufacturing cost can be reduced.

According to a fifteenth aspect, the first reserve tank and the second reserve tank of the reserve tank device in the eleventh aspect are integrally formed with each other. The cooling water inlet through which the cooling water is supplied and a cap configured to cover the cooling water inlet are disposed at an upper portion of the first reserve tank.

When the cooling water is supplied into the first reserve tank through the cooling water inlet of the first reserve tank in a state in which the passage switching member allows the cooling water to flow between the first auxiliary machine cooling circuit and the second auxiliary machine cooling circuit, the cooling water is supplied into both the first auxiliary machine cooling circuit and the second auxiliary machine cooling circuit. The reserve tank device commonly uses the cooling water inlet of the first reserve tank when the cooling water is supplied into both the first auxiliary machine cooling circuit and the second auxiliary cooling circuit. Therefore, a cooling water inlet is not necessarily disposed in the second reserve tank and the second reserve tank can be downsized.

According to a sixteenth aspect, the passage switching member of the reserve tank device in the above eleventh aspect includes a connecting passage fluidly connecting the first auxiliary machine cooling circuit to the second auxiliary machine cooling circuit and an on-off valve disposed in the connecting passage.

When the valve is located at a middle part of the connecting passage, the valve may be the on-off valve.

According to a seventeenth aspect, the passage switching member of the reserve tank device in the above eleventh aspect includes a connecting passage and a three-way valve. The connecting passage fluidly connects the first auxiliary machine cooling circuit to the second auxiliary machine cooling circuit. The three-way valve is disposed at a connecting point between the first auxiliary machine cooling circuit and the connecting passage or a connecting point between the second auxiliary cooling circuit and the connecting passage.

When the valve is disposed at the connecting point between the first auxiliary machine cooling circuit and the connecting passage or the connecting point between the second auxiliary machine cooling circuit and the connecting passage, a valve may be the three-way valve.

According to an eighteenth aspect, a liquid level in the first reserve tank or the second reserve tank of the reserve tank device in the above eleventh aspect can be visually recognized by an operator. When the operator recognizes that the amount of the cooling water in the first reserve tank or the second reserve tank is equal to or greater than a predetermined value with its eyes, the operator manually operates the passage switching member to forbid the cooling water to flow between the first auxiliary machine cooling circuit and the second auxiliary machine cooling circuit.

According to a nineteenth aspect, the reserve tank device in the above eleventh aspect further includes a liquid level detecting device and a controller. The liquid level detecting device is disposed in the first reserve tank or the second reserve tank. The controller automatically operates the passage switching member to forbid the cooling water to flow between the first auxiliary machine cooling circuit and the second auxiliary machine cooling circuit upon determining, based on signals outputted from the liquid level detecting device, that the amount of the cooling water in the first reserve tank or the second reserve tank is equal to or greater than a predetermined value.

When it is completed to supply the cooling water into both the first auxiliary machine cooling circuit and the second auxiliary machine cooling circuit, the controller automatically operates the passage switching member to forbid the cooling water to flow between the first auxiliary machine cooling circuit and the second auxiliary machine cooling circuit.

According to a twelfth aspect, the reserve tank device in the above eleventh aspect includes a controller configured to operate the passage switching member to forbid the cooling water to flow between the first auxiliary machine cooling circuit and the second auxiliary cooling circuit when the vehicle is traveling.

When the vehicle is traveling, the controller automatically operates the passage switching member to forbid the cooling water to flow between the first auxiliary machine cooling circuit and the second auxiliary machine cooling circuit. The controller can determine whether the vehicle is traveling or not by, for example, detecting rotation signals of a tire.

According to a twenty first aspect, the first auxiliary machine cooling circuit and the second auxiliary machine cooling circuit described in the eleventh aspect may be used for a water cooling type intercooler, an inverter cooler, or a battery cooler.

The auxiliary machines that are cooling targets of the cooling water circulating through the first auxiliary machine cooling circuit and the second auxiliary machine cooling circuit may be a supercharged intake air, an inverter, or a battery.

What is claimed is:

1. A reserve tank device disposed in both an engine cooling circuit through which a cooling water for cooling an internal combustion engine mounted in a vehicle circulates and an auxiliary machine cooling circuit through which a cooling water for cooling an auxiliary machine mounted in the vehicle circulates, the reserve tank device comprising:
a first reserve tank configured to reserve the cooling water circulating through the engine cooling circuit;
a second reserve tank configured to reserve the cooling water circulating through the auxiliary machine cooling circuit;
a passage switching member configured to selectively allow and forbid the cooling water to flow between the engine cooling circuit and the auxiliary machine cooling circuit; and
a gas-liquid separator disposed in the first reserve tank and configured to separate bubbles from the cooling water flowing through the first reserve tank.

2. The reserve tank device according to claim 1, wherein
the gas-liquid separator is not disposed in the second reserve tank, or
the gas-liquid separator is disposed in both the first reserve tank and the second reserve tank such that an area occupied by the gas-liquid separator in the second reserve tank is smaller than an area occupied by the gas-liquid separator in the first reserve tank.

3. The reserve tank device according to claim 1, wherein
the first reserve tank is integrally formed with the second reserve tank to constitute a single reserve tank, and
the single reserve tank includes only a single pair of a cooling water inlet through which the cooling water is supplied into the single reserve tank and a cap that opens and closes the cooling water inlet.

4. The reserve tank device according to claim 1, wherein
the first reserve tank is integrally formed with the second reserve tank to constitute a single reserve tank, and
a cooling water inlet through which the cooling water is supplied into the single reserve tank and a cap that opens and closes the cooling water inlet are disposed in an upper portion of the first reserve tank.

5. The reserve tank device according to claim 1, wherein
the passage switching member includes a connecting passage that connects the engine cooling circuit to the auxiliary machine cooling circuit and an on-off valve that is disposed in the connecting passage.

6. The reserve tank device according to claim 1, wherein
the passage switching member includes a connecting passage that connects the engine cooling circuit to the auxiliary machine cooling circuit and a three-way valve that is disposed at a connecting point between the engine cooling circuit and the connecting passage or a connecting point between the auxiliary machine cooling circuit and the connecting passage.

7. The reserve tank device according to claim 1, wherein
the passage switching member is manually operated to forbid the cooling water to flow between the engine cooling circuit and the auxiliary machine cooling circuit when an amount of the cooling water, which is visually detected, in the first reserve tank or the second reserve tank is equal to or greater than a predetermined value.

8. The reserve tank device according to claim 1, further comprising:
a liquid level detecting device disposed in the first reserve tank or the second reserve tank, and
a controller configured to operate the passage switching member to forbid the cooling water to flow between the engine cooling circuit and the auxiliary machine cooling circuit upon determining, based on a signal from the liquid level detecting device, that an amount of the cooling water in the first reserve tank or the second reserve tank is equal to or greater than a predetermined value.

9. The reserve tank device according to claim 1 further comprising a controller configured to operate the passage switching member to forbid the cooling water to flow between the engine cooling circuit and the auxiliary machine cooling circuit when the vehicle is traveling.

10. The reserve tank device according to claim 1, wherein
the auxiliary machine cooling circuit is used for a water cooling type intercooler, an inverter cooler, or a battery cooler.

11. A reserve tank device disposed in a plurality of auxiliary machine cooling circuits through which a cooling water to cool a plurality of auxiliary machines mounted in a vehicle circulates, the reserve tank device comprising:
a first reserve tank configured to reserve the cooling water that circulates though a first auxiliary machine cooling circuit of the plurality of auxiliary machine cooling circuits;
a second reserve tank configured to reserve the cooling water that circulates through a second auxiliary machine cooling circuit of the plurality of auxiliary machine cooling circuits;
a passage switching member configured to selectively allow and forbid the cooling water to flow between the first auxiliary machine cooling circuit and the second auxiliary machine cooling circuit; and
a gas-liquid separator disposed in the first reserve tank and configured to separate bubbles from the cooling water flowing through the first reserve tank.

12. A cooling system mounted in a vehicle comprising:
the reserve tank device according to claim 1; and
a plurality of cooling circuits through which the cooling water reserved in the first reserve tank and the second reserve tank of the reserve tank device circulates to cool an internal combustion engine or an auxiliary machine mounted in the vehicle.
